(19) United States
(12) Patent Application Publication
(10) Pub. No.: US 2025/0336010 A1
(43) Pub. Date: Oct. 30, 2025

(54) Water Timer

(71) Applicant: Felipe Ospina, Coral Gables, FL (US)

(72) Inventor: Felipe Ospina, Coral Gables, FL (US)

(21) Appl. No.: 18/650,108

(22) Filed: Apr. 30, 2024

(51) Int. Cl. G06Q 50/06; G01F 1/667; G04F 10/00

(52) U.S. Cl. CPC G06Q 50/06; G01F 1/667; G04F 10/00

(57) ABSTRACT

The Water Timer represents a revolutionary advancement in water conservation technology, offering a sleek, waterproof device designed to enhance time management and promote water-saving habits. This innovative solution integrates miniature vibrational sensors and Bluetooth Technology Enhancement (BTE) to provide real-time analytics on water flow rates and shower duration through a smartphone app. By encouraging shorter showers and delivering immediate feedback on usage, the Water Timer not only reduces environmental impact but also aids users in saving utility expenses. Its user-friendly design facilitates easy installation, with a clip that clamps onto the pipe and contains the vibrational sensors, along with a display screen that affixes to the wall, providing real-time feedback and analytics. The device is a two-piece system, comprising the clip with vibrational sensors and the display screen for real-time feedback, ensuring seamless integration into daily routines.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The Water Timer is a revolutionary device in the field of water conservation and efficiency management. It combines innovative technology with environmental consciousness to address the pressing need for sustainable water usage. By seamlessly integrating user-friendly features with practical utility, this device aims to revolutionize how individuals track and manage their water consumption, ultimately contributing to global efforts for conservation and cost savings.

### Description of the Related Art

Water management and the reduction of shower water wastage have become increasingly critical issues in recent years due to growing concerns about water scarcity and environmental sustainability. With population growth and urbanization, the demand for freshwater is outpacing the available supply in many regions worldwide. Consequently, there is a pressing need for innovative solutions to conserve water and reduce wastage, particularly in domestic settings such as households and residential buildings. Traditional shower systems often lack efficiency and fail to provide users with real-time feedback on their water usage habits. Thus, there is a significant opportunity to develop smart technologies that can monitor and optimize water consumption during showers to promote sustainable living.

Users of water management systems and shower water wastage reduction technologies typically seek solutions that are easy to install, user-friendly, and effective in reducing water usage without compromising on comfort or convenience. They may also value features such as real-time monitoring capabilities, smartphone integration, and customizable settings to align with their individual preferences and conservation goals. Additionally, users may prioritize products that offer cost savings on utility bills and contribute to environmental conservation efforts. Overall, the ideal water management solution should be accessible, affordable, and compatible with existing plumbing infrastructure to encourage widespread adoption among households and commercial establishments.

According to research conducted by the Environmental Protection Agency (EPA), the average American household uses approximately 17.2 gallons of water per shower, with older showerheads consuming even more. This translates to millions of gallons of water being wasted each day across the United States alone. Moreover, studies have shown that inefficient shower systems contribute significantly to household water bills, accounting for a substantial portion of overall water usage and expenses. In response to these challenges, various initiatives and regulations have been implemented to promote water conservation, including the development of water-saving technologies and the adoption of efficient plumbing fixtures in residential and commercial buildings.

In recent years, there have been several notable innovations in water management aimed at reducing shower water wastage and promoting efficient water usage. These innovations include the development of smart shower systems equipped with sensors and connectivity features to monitor water flow rates, detect leaks, and provide users with real-time feedback on their water consumption habits. Additionally, advances in water-saving technologies, such as low-flow showerheads, aerators, and pressure-compensating valves, have helped minimize water wastage without sacrificing water pressure or shower quality. Furthermore, the integration of smartphone apps and cloud-based platforms has enabled users to track their water usage, set conservation goals, and receive personalized recommendations for optimizing water efficiency in their homes or businesses.

Multiple solutions have been presented in prior art. However, these solutions are limited and restricted to their conventional systems. As a result of intensive studies on the requirements, the present inventor aims to provide a novel and significant advancement in water management and shower water wastage reduction, offering a range of benefits to users and the environment. By providing real-time monitoring of water usage during showers and empowering users with actionable insights, the invention helps raise awareness about water conservation and encourages more sustainable behaviors. Moreover, by reducing shower water wastage, the invention contributes to cost savings on utility bills and promotes responsible stewardship of freshwater resources. Additionally, the invention's user-friendly design and compatibility with existing plumbing infrastructure make it accessible to a wide range of users, facilitating widespread adoption and maximizing its impact on water conservation efforts. Overall, the invention represents a promising solution to address the growing challenges of water scarcity and environmental sustainability in domestic settings.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to promote water conservation by encouraging shorter showers, thereby reducing water wastage and preserving precious resources.

It is the objective of the invention to offer a product design to empower users with real-time analytics on water flow rates and shower duration, fostering awareness and accountability for their water usage habits.

It is the objective of the invention to enhance time management by providing immediate feedback on shower lengths, helping users optimize their daily routines.

It is the objective of the invention to contribute to environmental sustainability by reducing the carbon footprint associated with excessive water consumption.

It is the objective of the invention to help users save on utility expenses by promoting efficient water usage and reducing monthly water bills.

It is the objective of the invention to simplify installation and usage, making it accessible to users of all technical backgrounds and ages.

It is the objective of the invention to offer peace of mind to users by providing a reliable and convenient solution for monitoring and managing water usage.

It is the objective of the invention to instill eco-conscious habits in individuals and households, fostering a culture of sustainability and responsible resource management.

It is also the objective of the invention to provide a two-piece configuration comprising a clip for the pipe and a display screen for the wall, the device offers convenience and ease of use. This user-friendly design ensures straightforward installation and accessibility, allowing users to seamlessly incorporate water conservation practices into their daily routines.

It is the objective of the invention to contribute to global efforts for water conservation and environmental protection, one shower at a time.

It is the objective of the invention to empower users to make informed choices about their water usage, leading to positive behavioral changes and long-term sustainability benefits.

Thus, it is the objective to provide an advancement in water conservation techniques. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows the installed view of the assembly incorporating the embodiments of the invention.

FIG. 2 shows a working view of the proposed assembly incorporating the embodiments of the invention.

FIG. 3 shows another working view of the assembly incorporating the embodiments of the invention.

FIG. 4 shows the top working view of the assembly incorporating the embodiments of the invention.

FIG. 5 shows the front working view of the assembly incorporating the embodiments of the invention.

FIG. 6 shows a side working view of the assembly incorporating the embodiments of the invention.

FIG. 7 shows front-installed view of the assembly incorporating the embodiments of the invention.

FIG. 8 shows multiple parts of the assembly incorporating the embodiments of the invention.

FIG. 9A shows another view detailing parts of the assembly incorporating the embodiments of the invention.

FIG. 9B shows another installed view of the assembly incorporating the embodiments of the invention.

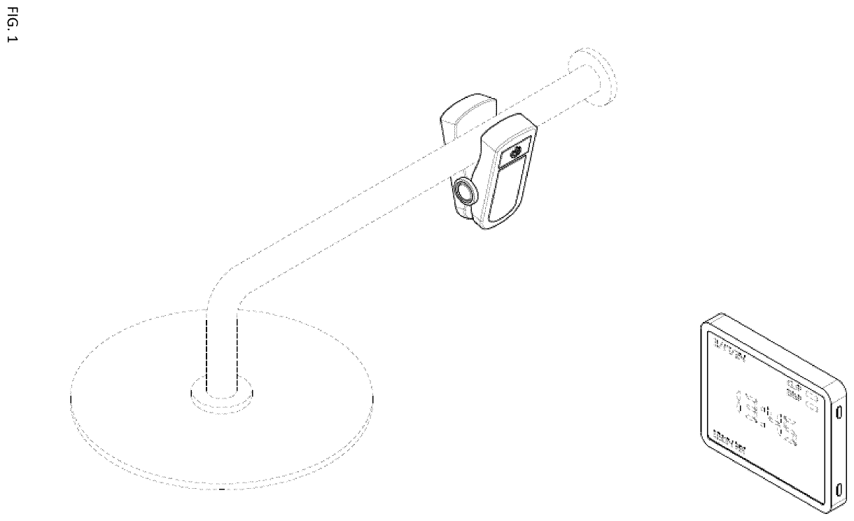

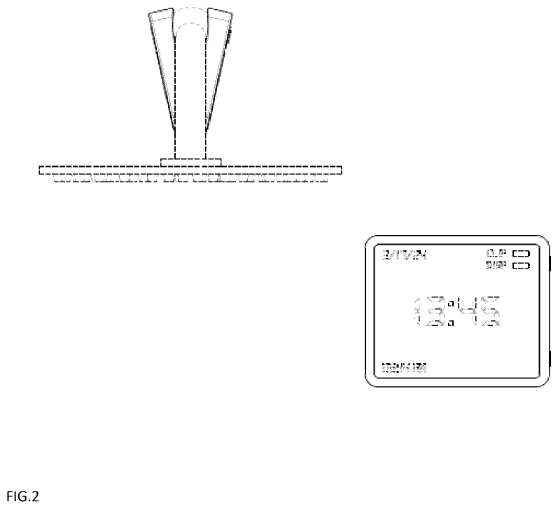

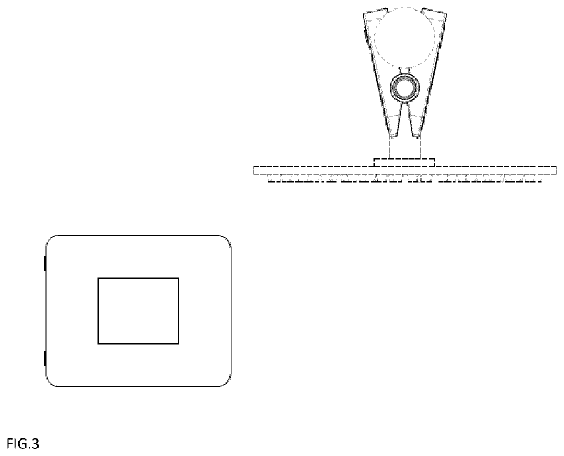

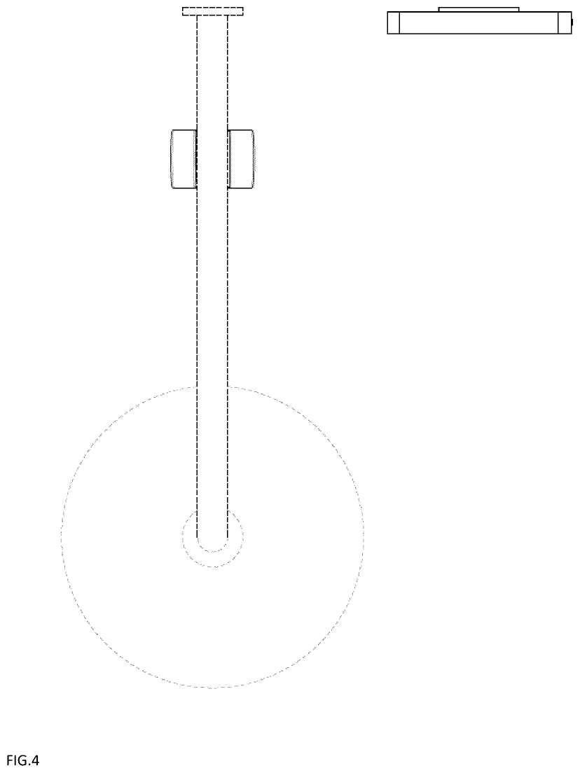

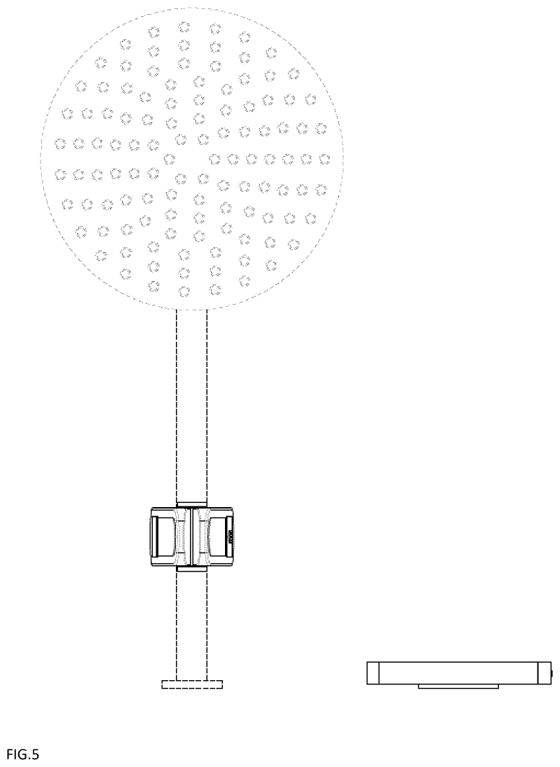

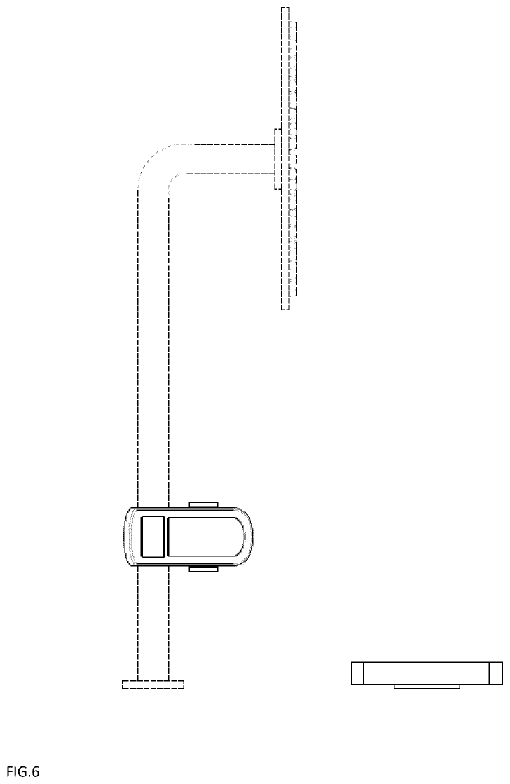

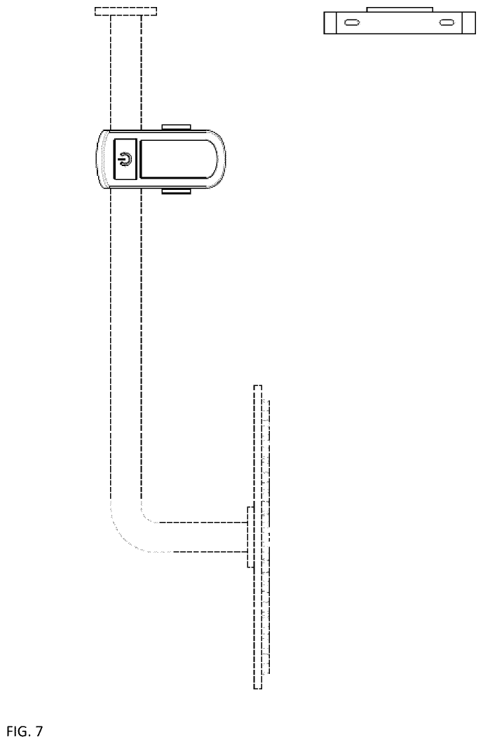

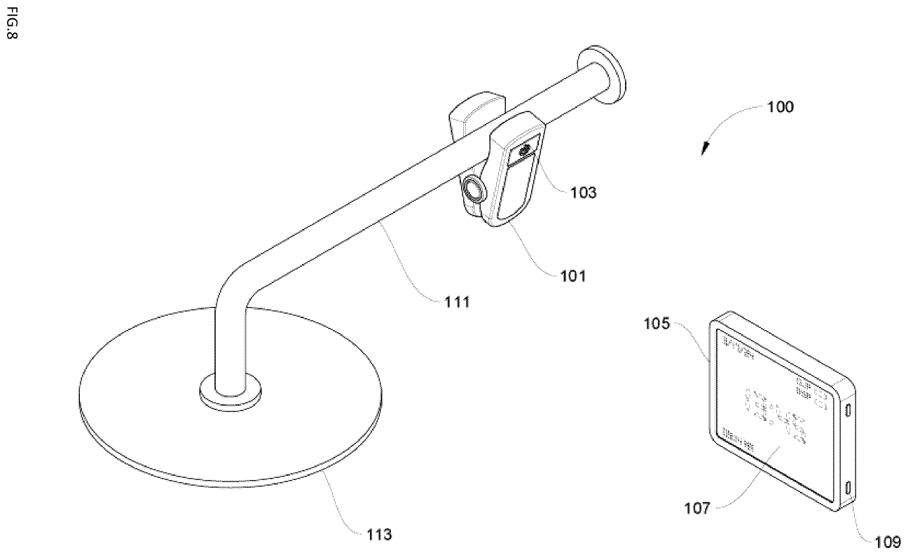

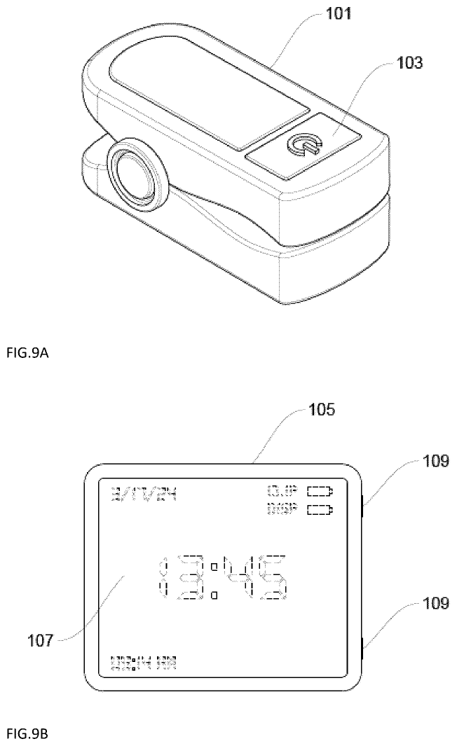

The apparatus and method components have been represented where appropriate by conventional symbols in the drawings, showing only those specific details.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention provides a novel method for a The Water Timer represents a cutting-edge solution in the realm of water conservation and cost savings. Its sleek and waterproof design makes it an ideal addition to any shower, where it serves as a proactive tool for reducing water wastage and utility expenses. With its user-friendly interface and intuitive app, the Water Timer revolutionizes time management by allowing users to effortlessly track their shower lengths and set personalized conservation goals. By encouraging shorter showers, the device not only minimizes environmental impact but also promotes responsible water usage habits among individuals. With its “Clip it and Stick it” feature, the Water Timer seamlessly integrates into users' daily routines, making every drop of water count towards a more sustainable future.

As per its preferred embodiments, the device comprises two distinct components: the clip and the display screen. The clip serves as the anchor point, securely clamping onto the pipe where it houses the vibrational sensors. These sensors are pivotal in detecting and capturing real-time data pertaining to the flow and condition of the fluid passing through the pipe. Designed for ease of installation, the clip ensures a snug fit onto the pipe, enabling accurate and reliable data collection without interfering with the flow of the fluid.

As per its further embodiments, the display screen acts as the user interface, providing immediate access to the gathered data and analytics. Once affixed to the wall, the display screen offers a clear and intuitive interface for users to visualize real-time feedback on the fluid flow, pressure, and other relevant parameters. Through the display screen, users can monitor the performance of the system and identify any anomalies or irregularities in the flow patterns. Moreover, the display screen is equipped with wireless connectivity capabilities, allowing seamless integration with the accompanying mobile app. Users can access comprehensive analytics and detailed information about the fluid flow directly from their smartphones, enabling remote monitoring and management of the system from anywhere, at any time. This integration of hardware and software components ensures a user-friendly and efficient solution for monitoring and managing fluid systems with ease and precision.

As per its further embodiments, the proposed design provides the first automatic smart shower clock/timer, the device utilizes miniature vibrational sensors and Bluetooth Technology Enhancement (BTE) to provide users with real-time analytics on water flow rates and shower duration. This groundbreaking approach enables users to gain immediate feedback on their water usage habits, empowering them to make informed decisions about their shower routines. By leveraging advanced sensors and connectivity features, the Water Timer delivers unparalleled insights into water consumption, promoting efficient usage while enhancing time management and cost savings.

As per its further embodiments, the Water Timer is more than just a device—it's a transformative tool that redefines the way individuals interact with water in their daily lives. By seamlessly integrating into users' shower routines, the device instills a sense of environmental consciousness and

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter. responsibility, encouraging mindful water usage practices. Its intuitive app interface serves as a digital companion, guiding users towards shorter showers and greater water conservation efforts. With its easy clamp installation and user-friendly features, the Water Timer makes sustainable living accessible to everyone, regardless of their technical expertise or familiarity with water-saving technologies.

As per its additional embodiments, the Water Timer's impact extends beyond individual households, offering broader implications for environmental sustainability and resource management. By reducing water wastage at the individual level, the device contributes to larger efforts to conserve freshwater resources and mitigate the effects of water scarcity. Its seamless integration into existing shower infrastructure makes it a scalable solution with the potential to drive significant reductions in water consumption on a global scale. As individuals embrace the Water Timer as part of their daily routines, they become active participants in the movement towards a more sustainable future for generations to come.

As per its further embodiments, the Water Timer represents a paradigm shift in water conservation and cost savings, offering a holistic solution that combines innovative technology with environmental consciousness. Its sleek design, user-friendly interface, and real-time analytics empower users to take control of their water usage habits and make meaningful contributions to conservation efforts. With its seamless integration into daily routines and potential for widespread adoption, the Water Timer has the power to transform the way we interact with water, one shower at a time.

1. A water conservation device comprising user-friendly app integration for tracking shower lengths and setting conservation goals.
A method for promoting water-saving habits, utilizing real-time analytics on water flow rates and shower duration.
The method wherein the analytics are provided through Bluetooth Technology Enhancement (BTE).
An innovative shower clock/timer, leveraging miniature vibrational sensors for precise monitoring of water usage.
The shower clock/timer of claim 2 comprising a system for encouraging efficient water use, comprising easy clamp installation for convenient setup.
The system of claim 2, further comprising immediate feedback on water consumption to promote awareness and behavior change.
A method for reducing environmental impact and utility expenses through shorter showers and optimized water usage.
The method facilitated by the Water Timer's user-friendly interface and intuitive design.
An apparatus for enhancing time management and cost savings in water usage, featuring a modern and sleek aesthetic.
The apparatus, designed for “Clip it and Stick it” installation to seamlessly integrate into daily routines.
The device of claim 3 providing global contributions to water conservation efforts through efficient usage tracking and goal-setting capabilities.
A method for revolutionizing water conservation technology, driven by innovative features and user-centric design principles.
The water conservation device, comprising a clip component equipped with vibrational sensors for attachment to a pipe, and a display screen component affixed to a wall for real-time feedback and analytics display.
The water conservation device, wherein the water-saving system consists of two distinct pieces:
clamp with integrated vibrational sensors designed to attach to a pipe; and,
a display screen for mounting on a wall, providing users with real-time feedback and analytics regarding water usage.
